(19) United States
(12) Patent Application Publication
(10) Pub. No.: US 2025/0297795 A1
(43) Pub. Date: Sep. 25, 2025

(54) PORTABLE ICE SHAVER SYSTEM FOR A PORTABLE DRINK MAKER SYSTEM

(71) Applicant: Sunbeam Products, Inc., Atlanta, GA (US)

(72) Inventors: Steve Vernaglia, Delray Beach, FL (US); Adam Gralewski, Kalamazoo, MI (US)

(21) Appl. No.: 18/864,078

(22) PCT Filed: May 17, 2023
(86) PCT No.: PCT/US2023/067100

§ 371 Date: Nov. 8, 2024

Related U.S. Application Data
(60) Provisional application No. 63/364,854, filed on May 17, 2022.

(51) Int. Cl. F25C 5/12; A23G 9/08; A47J 43/044; A47J 43/07

(52) U.S. Cl. CPC F25C 5/12; A23G 9/08; A47J 43/044; A47J 43/0711

(57) ABSTRACT

A drink maker system is provided that may include an ice maker system and a blender system. The ice maker system may include an ice shaver module and an ice reservoir. The ice maker system may be positioned substantially on top of the blender system. A shaft of a plunger mechanism of the ice shaver module may extend into a gear box of the ice shaver module. The plunger mechanism and shaft are downwardly biased such that ice which is placed in the ice reservoir is pressed downwardly to be shaved before it is introduced into the blender system to be blended.

### CROSS-REFERENCE TO RELATED APPLICATIONS

The present application claims priority to U.S. Provisional Patent Application No. 63/364,854, filed May 17, 2022, the entire contents of which are hereby incorporated by reference.

### FIELD OF THE INVENTION

The present invention relates generally to a portable ice shaver system. More particularly, the present invention relates to a portable ice shaver system for a portable drink maker system.

### BACKGROUND OF THE INVENTION

Various types of ice shaver systems exist for use in preparing shaved ice for blended beverages. Currently, consumers may use an independent ice shaver system to shave ice and add the shaved ice to a blender system to combine with other various ingredients. Alternatively, consumers may use a drink maker system that includes both an ice shaver system and a blender system. However, such “all-in-one” solutions having each of a shaver and blender system are bulky and not easily portable. For example, in existing systems, the ice shaver system is located above and behind the blender system, and the ice shaver motor is located below the ice shaver system.

Such systems take up a significant amount of space and are difficult to transport. This difficulty is due, in part, to the motor and gear box used to drive the shaver's motor being placed below the shaft that drives rotation of the shaver system. Such a configuration makes the device larger than necessary, as the device can be taller or wider than necessary. Further, many existing drink maker systems lack safety features to protect consumers from injury.

### SUMMARY OF THE INVENTION

The present invention provides a portable ice shaver system for preparing shaved ice for use in blended beverages, such as juices, smoothies, shakes, and cocktails. More particularly, a portable ice shaver system is provided that can be used as part of a portable drink maker system to prepare blended beverages. The portable drink maker system may include a blender system and an ice shaver system.

To create shaved ice, ice may be placed within an ice reservoir of the ice shaver system. A shaver motor may activate a gear box, which in turn may rotate a plunger mechanism in a circular motion. While the plunger mechanism rotates, a spring of the plunger mechanism may force the plunger mechanism in a downward direction towards a shaver blade and an opening at the bottom of the ice reservoir. When the plunger mechanism rotates and moves in a downward direction, the shaver plate may push ice downwardly toward the shaver blade. There, the ice may be shaved before it exits the ice reservoir through an opening at the bottom of the ice reservoir. The ice shaver system may be located on top of the blender system, such that when the shaved ice exits through the opening of the ice reservoir, the shaved ice may fall into the blender system. The shaved ice may then be mixed and blended together with other various ingredients within the blender system to create a blended beverage.

Unlike existing systems, the present invention provides a shaft which extends into a gear box that drives rotation of the plunger mechanism. This configuration may reduce the overall size of the system and make it fit on consumers' shelves using less space, fit under cabinetry, or be generally more mobile for “on the go” uses. Further, unlike existing systems, the present invention may include a safety mechanism configured to retract the shaver blade downwardly and away from the ice reservoir when the blender system and ice shaver system are disengaged from one another.

### BRIEF DESCRIPTION OF THE DRAWINGS

For a better understanding of the present invention, reference may be made to the following accompanying drawings.

FIG. 1 is a perspective view of a portable drink maker system with a portable ice shaver system constructed according to the teachings hereof.

FIG. 2 is an exploded view of the portable drink maker system with the portable ice shaver system of FIG. 1.

FIG. 3 is a cross-sectional view of the portable drink maker system with the portable ice shaver system of FIG. 1.

FIGS. 4A-4D are perspective views of various springs of the portable ice shaver system of the portable drink maker system of FIG. 1.

FIGS. 5A-5C are perspective views of various shaver blades of the portable ice shaver system of the portable drink maker system of FIG. 1.

FIG. 6 is an exploded view of the portable drink maker system of FIG. 1.

FIG. 7 is a perspective view showing a locking mechanism of the portable drink maker system of FIG. 1.

FIGS. 8A and 8B are perspective views showing a handle feature of the portable drink maker system of FIG. 1.

FIG. 9A is a partial elevation view showing a control panel of the portable drink maker system of FIG. 1.

FIG. 9B is a partial elevation view showing a battery indicator of the portable drink maker system of FIG. 1.

FIG. 10 is a perspective view showing a charging port of the portable drink maker system of FIG. 1.

### DETAILED DESCRIPTION OF THE INVENTION

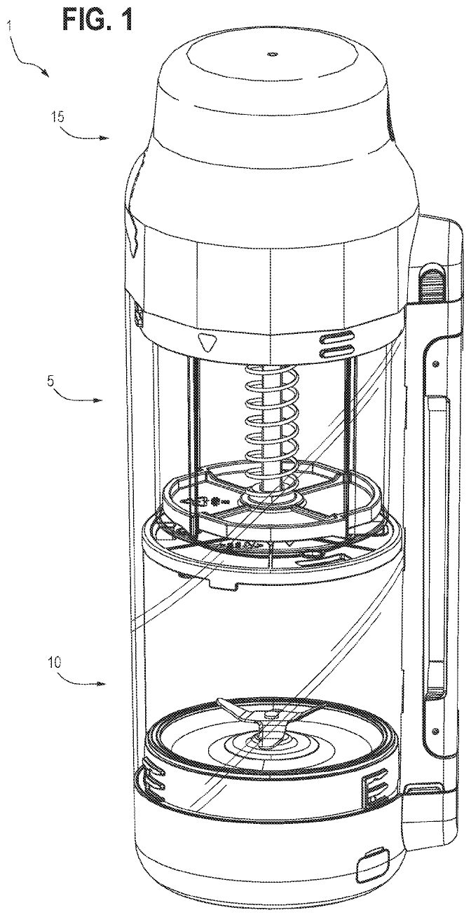

Turning first to FIG. 1, a portable drink maker system 1 may include an ice shaver system 5 which may be used in combination with a blender system 10. Generally, the ice shaver system 5 may be used to shave ice to incorporate into the blender system 10 to ultimately create a blended beverage. The ice shaver system 5 may be selectively engaged with the blender system 10 such that it may rest atop the blender system 10. This configuration may result in a smaller and more compact portable drink maker system 1. The ice shaver system 5 may take on a number of sizes. In one embodiment, the ice shaver system 5 may be less than six inches tall. According to various embodiments, the ice shaver system 5 may be three inches or less. The blender system 10 may be represented by a traditional blender system for mixing and blending various ingredients to create blended beverages, such as juices, smoothies, shakes, cocktails, other frozen beverages, etc. A lid 15 may attach to a top end of the ice shaver system 5 and may prevent food and liquid from exiting the portable drink maker system 1.

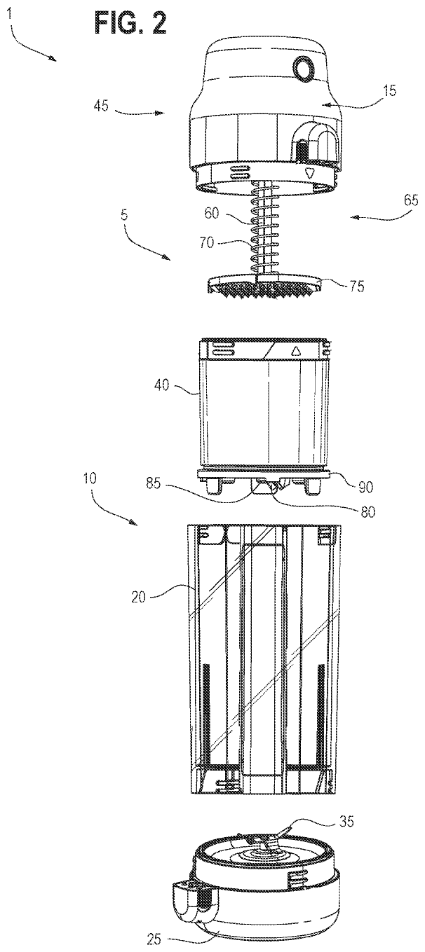

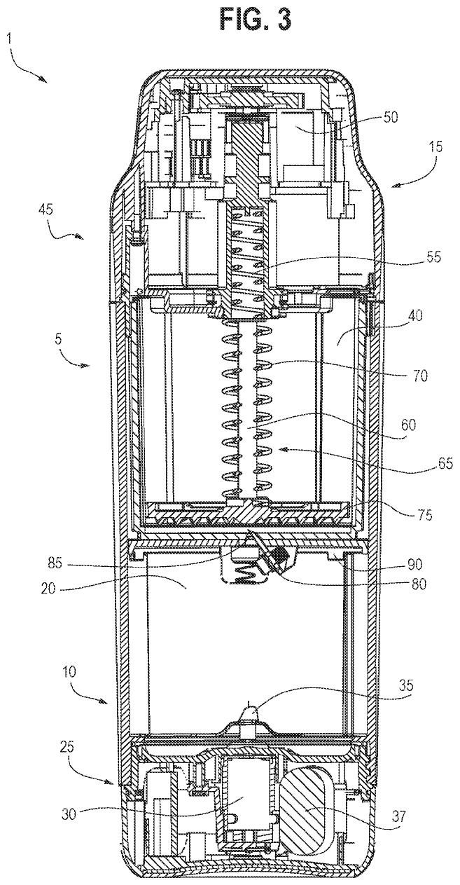

Turning to FIGS. 2 and 3, the blender system 10 may include a blender vessel 20 configured to contain ingredients to be used for preparing a blended beverage. In one embodiment, the blender vessel 20 may be partially or fully transparent. According to various embodiments, the blender vessel 20 may be opaque or solid. A lower end of the blender vessel 20 may be connected to a blender base 25. The blender vessel 20 may or may not be integrally formed with the blender base 25. A blender motor 30 (see FIG. 3) may be located within the blender base 25 and may, when instructed to do so, activate the blender blade 35 to mix and blend ingredients within the blender vessel 20. The blender motor 30 may be powered by a battery 37 or other power source (see FIG. 3), which may be placed within the blender base 25. The battery 37 may be represented as a single-use battery or a rechargeable battery.

The ice shaver system 5 may include an ice reservoir 40 configured to receive ice. An ice shaver module 45 may be provided to shave ice contained within the ice reservoir 40. The ice shaver module 45 may be powered by a shaver motor 50, which may be located within the lid 15. The shaver motor 50 may be powered by battery 37 (or other power source), which may be placed within the blender base 25. The battery 37 may be represented as a single-use battery or a rechargeable battery.

The shaver motor 50 may be configured to rotate a gear box 55 when the shaver motor 50 is activated. According to one embodiment, the gear box 55 is located within the lid 15. The gear box 55 may be connected to a shaft 60 of a plunger mechanism 65, such that when the gear box 55 is rotated, so too are the plunger mechanism 65 and its shaft 60. In one embodiment, the shaft 60 of the plunger mechanism 65 extends into a center of the gear box 55. The shaft 60 may be keyed to engage the gear box 55. According to various embodiments, the shaft 60 may have a non-circular cross-section to engage with the gear box 55, such as a square, rectangle, oval, etc. The shaver motor 50 may or may not sit on top of the shaft 60 to drive the rotation of the plunger mechanism 65. With a configuration where the shaft 60 extends into the gear box 55, the shaver motor 50 may be placed adjacent to the shaft 60, rather than on top of the shaft 60. This may reduce the height of the plunger mechanism 65, and as a result, may reduce the overall height of the portable drink maker system 1.

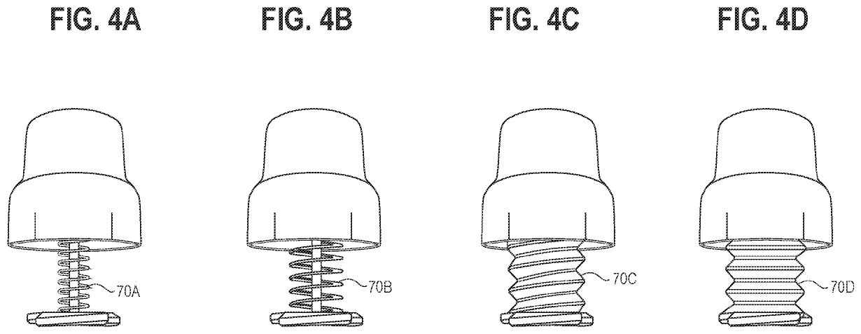

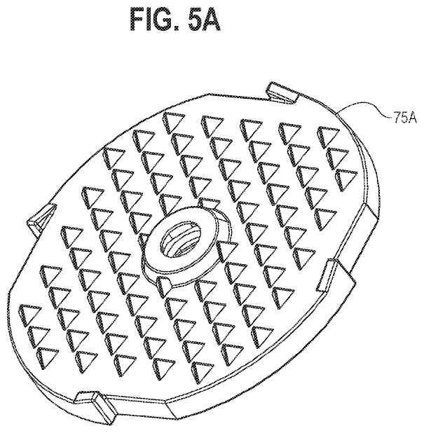

The plunger mechanism 65 may be connected to an interior of the lid 15. In one embodiment, the plunger mechanism 65 extends vertically upward through the lid 15 and downward through the ice reservoir 40. The plunger mechanism 65 may include a spring 70 placed around the shaft 60. Various spring types may be used for spring 70 of plunger mechanism 65, as described in greater detail with reference to FIGS. 4A-4D below. The plunger mechanism 65 may further include a shaver plate 75 connected to a bottom end of the shaft 60. Various types of shaver plates may be used for the shaver plate 75, as described in greater detail with reference to FIGS. 5A-5C below. The ice shaver module 45 may further include a shaver blade 80. In one embodiment, the ice shaver module 45 includes multiple shaver blades 80. The shaver blade 80 is preferably positioned and located within an opening 85 at a bottom end of the ice reservoir 40.

To generate shaved ice and, subsequently prepare a blended beverage, ice may be placed within the ice reservoir 40 of the ice shaver system 5, and the remaining beverage ingredients may be placed within the blender vessel 20 of the blender system 10. When the portable drink maker system 1 is assembled with ice in the ice reservoir 40, the plunger mechanism 65 may be in a compressed position. Specifically, plunger mechanism 65 may be pushed upwards towards the lid 15.

When the plunger mechanism 65 rotates, the spring 70 may force the plunger mechanism 65 in a downward direction towards the shaver blade 80 and the opening 85 at the bottom of ice reservoir 40. As the plunger mechanism 65 rotates and moves downwards, the shaver plate 75 may push the ice toward the shaver blade 80 in the opening 85, where the ice may be shaved. The shaved ice may exit the ice reservoir 40 through the opening 85 and may subsequently enter the blender vessel 20. As the shaved ice begins to exit the ice reservoir 40 through the opening 85, the plunger mechanism 65 may move into a decompressed position, and the plunger mechanism 65 may be pushed downwards towards the bottom of ice reservoir 40. Such decompressed position of the plunger mechanism 65 is illustrated in FIG. 3. Once the shaved ice enters the blender vessel 20, the shaved ice and other various beverage ingredients may be mixed and blended together via the blender blade 35 and the blender motor 30 using known mechanisms to produce a blended beverage.

As illustrated in FIGS. 4A-4D, the spring 70 may be represented by a wire spring 70A, plastic spring 70B, helix bellow spring 70C, or pleat bellow spring 70D, respectively. The spring 70 may alternatively be represented by a compression spring or a wave spring (not illustrated). As illustrated in FIGS. 5A-5C, the shaver plate 75 may be represented by stepped grooves 75A, offset teeth 75B, or spiked terrain 75C, respectively.

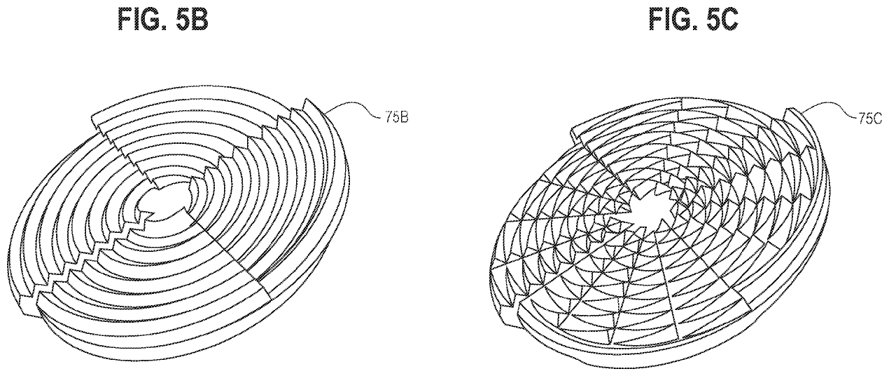

Turning to FIG. 6, a blade guard 90 may be attached to a bottom end of the ice shaver system 5 and may provide an enhanced safety measure. Specifically, the blade guard 90 may be attached to a bottom end of the ice reservoir 40. The blade guard 90 may surround and be attached to the shaver blade 80. The blade guard 90 may be spring loaded. In one embodiment, the blade guard 90 is preferably spring loaded against the bottom of the ice reservoir 40 such that when the ice shaver system 5 is disengaged from the blender system 10, the blade guard 90 releases downwardly and is distanced from the bottom of the ice reservoir 40. This may create a gap 95 between the ice reservoir 40 and the blade guard 90. When blade guard 90 releases downward, the shaver blade 80, which may be attached to the blade guard 90, may also move in a downward direction and may be pushed down and away from the opening 85. This may protect a user from being injured by the shaver blade 80 when the user reaches into the ice reservoir 40. To return the shaver blade 80 to its shaving position, the ice shaver system 5 may be engaged with the blender system 10. One or more vertical ribs 100 may be formed within an interior of the blender system 10 and may be configured to push the blade guard 90 upwards against the ice reservoir 40. When the ribs 100 and the blade guard 90 abut one another, the gap 95 may be closed, and the shaver blade 80 may retract upwards through the opening 85 and into the ice reservoir 40.

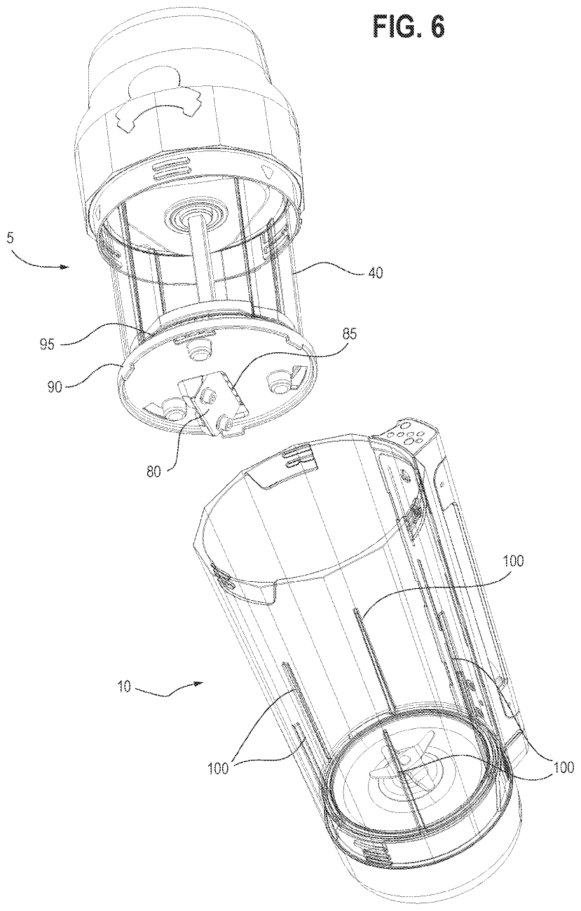

Turning to FIG. 7, in one embodiment, the portable drink maker system 1 may include an electrical spine 105. The electrical spine 105 may include an upper connector 110, a middle connector 115, and a lower connector 120. The electrical spine 105 may be used to power one or both of the shaver motor 50 and the blender motor 30 (not illustrated). When the upper connector 110, the middle connector 115, and the lower connector 120 are aligned on top of one another and connected, an electrical circuit may be formed. This electrical circuit may activate one or both of the shaver motor 50 and the blender motor 30 (not illustrated). In one embodiment, pogo pin connectors are used to connect the upper connector 110, the middle connector 115, and the lower connector 120. However, alternative embodiments may use any other suitable connector(s).

The electrical spine 105 may also act as a locking mechanism to secure the components of the portable drink maker system 1 together. To engage the locking mechanism, the upper connector 110 may be rotated clockwise to align with and engage a top portion of the middle connector 115, while the lower connector 120 may be rotated counterclockwise to align with and engage a bottom portion of the middle connector 115. To disengage the locking mechanism, the upper connector 110 may be rotated counterclockwise to disengage from the top portion of the middle connector 115, while the lower connector 120 may be rotated clockwise to disengage from the bottom portion of the middle connector 115. In an alternative embodiment, the upper connector 110 may be rotated counterclockwise to engage the middle connector 115, while the lower connector 120 may be rotated clockwise to engage the middle connector 115. In such an embodiment, the upper connector 110 may be rotated clockwise to disengage the middle connector 115, while the lower connector 120 may be rotated counterclockwise to disengage the middle connector 115.

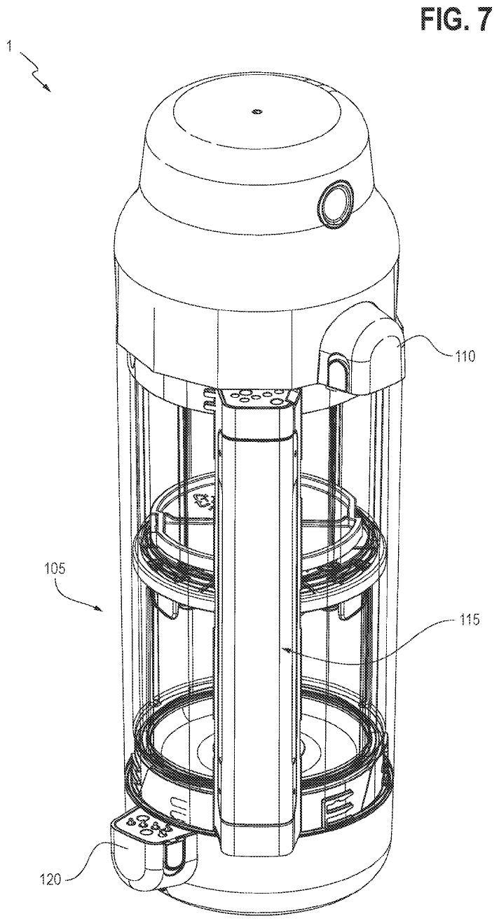

As illustrated in FIGS. 8A and 8B, the middle connector 115 may include a hand strap 125. The hand strap 125 may be used to assist a user when carrying the portable drink maker system 1 or pouring a beverage from the blender system 10.

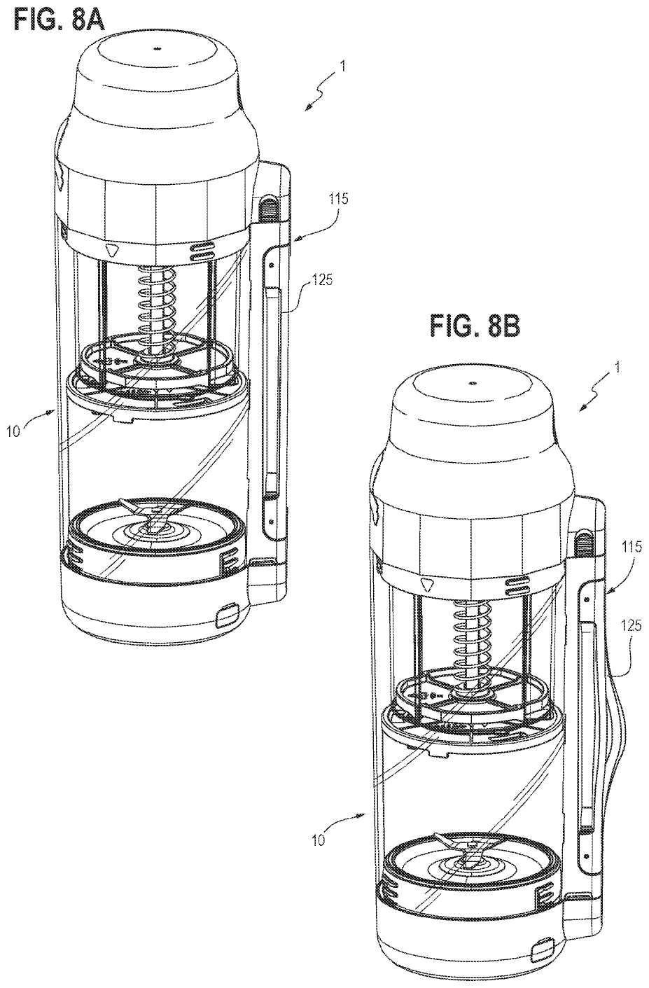

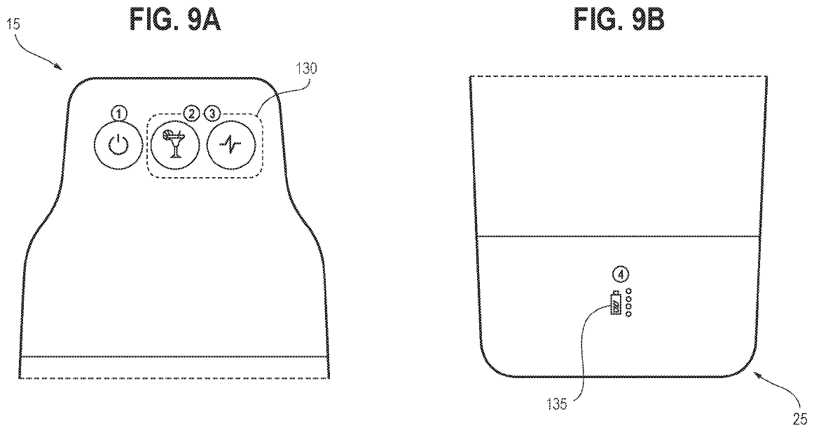

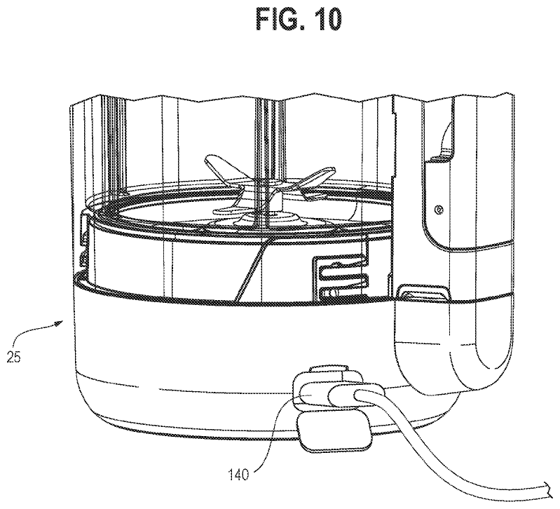

Turning to FIG. 9A, the lid 15 may include various power controls 130. The power controls 130 may control the operation of the portable drink maker system 1. For example, a user may utilize the power controls to activate the ice shaver system 5 and/or the blender system 10 (not illustrated). Such operations may include pre-programmed blending operations, manual blending operations, un-jamming functions, etc. As illustrated in FIG. 9B, the blender base 25 may also include a battery indicator 135 which may indicate the power level of the battery 37 powering the shaver motor 50 and/or the blender motor 30 (not illustrated). Turning to FIG. 10, the blender base 25 may include a power cord input 140 configured to receive a power cord to charge the battery 37 (not illustrated).

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

1. A drink maker system comprising:
an ice maker system comprising:
an ice shaver module; and
an ice reservoir; and
a blender system;
wherein the ice maker system is positioned substantially on top of the blender system, and wherein a shaft of a plunger mechanism of the ice shaver module extends into a gear box of the ice shaver module.

2. The drink maker system of claim 1, wherein the ice shaver module further comprises a shaver motor configured to activate the gear box.

3. The drink maker system of claim 1, wherein a lower portion of the plunger mechanism further comprises a shaver plate.

4. The drink maker system of claim 1, wherein the plunger mechanism is configured to rotate in a circular motion.

5. The drink maker system of claim 1, wherein a spring of the plunger mechanism is configured to force the plunger mechanism in a downward direction.

6. The drink maker system of claim 1, wherein the ice maker system further comprises a shaver blade positioned at a bottom end of the ice maker system.

7. The drink maker system of claim 6, wherein the shaver blade is configured to shave ice before it exits through an opening at the bottom end of the ice maker system.

8. The drink maker system of claim 1, further comprising a lid that is selectively attachable to the ice maker system.

9. An ice maker system comprising:
an ice shaver module comprising:
a gear box;
a shaver motor; and
a plunger mechanism; and
an ice reservoir;
wherein the plunger mechanism further comprises a shaft, and wherein the shaft extends into the gear box.

10. The ice maker system of claim 9, wherein the ice maker system is configured to engage with a blender system.

11. The ice maker system of claim 10, wherein the ice maker system is positioned substantially on top of the blender system.

12. The ice maker system of claim 9, wherein the shaver motor is configured to activate the gear box.

13. The ice maker system of claim 9, wherein a lower portion of the plunger mechanism further comprises a shaver plate.

14. The ice maker system of claim 9, wherein the plunger mechanism is configured to rotate in a circular motion.

15. The ice maker system of claim 9, wherein a spring of the plunger mechanism is configured to force the plunger mechanism in a downward direction.

16. The ice maker system of claim 9, further comprising a shaver blade positioned at a bottom end of the ice maker system, and wherein the shaver blade is configured to shave ice before it exits through an opening at the bottom end of the ice maker system.

17. The ice maker system of claim 9, wherein the ice maker system is configured to engage with a lid that is selectively attachable to the ice maker system.

18. An ice maker system comprising:
an ice shaver module comprising:
a gear box; and
a plunger mechanism;
wherein a shaft of the plunger mechanism extends into the gear box; and
a blender system that is selectively attachment to the ice shaver module.

19. The ice maker system of claim 18, wherein the ice shaver module further comprises a shaver motor configured to activate the gear box.

20. The ice maker system of claim 18, wherein the gear box is configured to rotate the shaft, and wherein the rotation of the shaft causes the plunger mechanism to rotate.
